(19) United States
(12) Patent Application Publication
(10) Pub. No.: US 2019/0026695 A1
(43) Pub. Date: Jan. 24, 2019

(54) SYSTEM AND METHOD FOR ARRANGING TRANSPORT VIA A VEHICLE TRAVELLING FROM AN ORIGIN TO A DESTINATION USING MULTIPLE OPERATORS

(71) Applicant: Jackfruit Systems Inc., Winnipeg (CA)

(72) Inventors: Yashavanth Kuntavalli Yajnanarayana, Winnipeg (CA); Sharan Savadattimath, Winnipeg (CA); Nitin Swarup Sharma, Winnipeg (CA)

(21) Appl. No.: 15/920,065

(22) Filed: Mar. 13, 2018

Related U.S. Application Data
(60) Provisional application No. 62/536,152, filed on Jul. 24, 2017.

(51) Int. Cl. G06Q 10/08; G08G 1/00; G06Q 10/06

(52) U.S. Cl. CPC G06Q 10/0834; G06Q 10/063112; G08G 1/202

(57) ABSTRACT

A method for arranging a transport via a vehicle travelling from an origin to a destination involves assigned multiple operators to the transport, each operating the vehicle for a portion of a trip between the origin and destination. A system for carrying out this method is configured for storing profiles of operators who can be assigned to the respective transport, and which is configured for receiving input about a transport which the system is supposed to arrange. Based on the information on the operators and the transport, the system determines switch-points at which selected operators are to change, such that one operator vacates the vehicle and another takes over operation so as to take the vehicle to the next stop along the trip of the transport. Once the switch-points are determined, the system dispatches itineraries to the assigned operators including the vehicle to be operated, departure information therefor, and arrival information therefor, which are provided for each leg of a trip an operator is assigned to.

This application claims the benefit under 35 U.S.C. 119(e) of U.S. Provisional application Ser. No. 62/536,152 filed 24 Jul. 2017.

### FIELD OF THE INVENTION

The present invention relates generally to transportation logistics, and more particularly to a system and method for making transport more efficient by sharing resources.

### BACKGROUND

For example, in today's long haul trucking industry, the goal of each company is to efficiently deliver cargo for their customers from one physical location to another as quickly and inexpensively as possible. Currently, trucking companies are faced with various constraints on driver regulations that may be preventing them from achieving the aforementioned industry objectives.

Presently, long haul truck drivers in many countries are prohibited from driving more than a prescribed number of hours in a day. In Canada, for example, this prescribed number is 13 hours per day. Consequently, a truck to which a driver is assigned so as to drive it to an end destination more than 13 hours away from its original location, sits idle for 11 hours per day before the driver is permitted to resume driving the truck towards its final destination. This equates to 45% of downtime per day, that is the time during which the truck is not in use. This results in poor efficiency of the truck carrying the cargo to get to its destination in the least possible time. Therefore, it may be desirable to find a solution which meets regulations applied to drivers that limit daily operating/driving hours while allowing the transport vehicle to continue in transit moving towards its final destination so as to not unnecessarily delay the shipment of cargo.

Trucking companies presently have the capability of monitoring locations, routes, and estimated time of arrival of their fleet trucks.

### SUMMARY OF THE INVENTION

According to an aspect of the invention there is provided a method for arranging a transport via a vehicle travelling from an origin to a destination using multiple operators for the transport, each operator operating the vehicle for a portion of a trip between the origin and destination. The method comprises the steps of: storing, on a control server, information on profiles of said multiple operators including operator location;

receiving, as input to the control server, information on the transport from a user planning the transport, including:
the origin, and
the destination;

determining, using the control server, switch-points for the transport at which operators are to change based on the profiles of the operators and the information on the transport, wherein selected ones of the operators are assigned to the transport;

and dispatching to the assigned operators using the control server an itinerary comprising the vehicle to be operated, departure information therefor, and arrival information therefor.

The operator location may be the operator home location.

The operator location alternatively may be a current operator location.

In one arrangement, there are a plurality of transports to be arranged via a plurality of vehicles, and the method further comprises a step of determining, using the control server, from the information on the transports, which of the transports are compatible having routes which can be overlapped, and the itinerary for each assigned operator includes a first trip leg and a second trip leg at the end of which the respective assigned operator is arranged at a next operator location which is dependent upon a respective one of the profiles of the assigned operator.

Thus the next operator location may be the operator home location or a different location if, for example, the operator's profile indicates that he/she is able to be away from home for a prescribed period of time.

Typically, each transport has a different origin and destination.

According to another aspect of the invention there is provided a method for arranging transports via vehicles travelling from different origins to different destinations using multiple operators each operating a respective one of the vehicles for a portion of a trip between the origin and destination for a respective one of the transports, the method comprising the steps of:

storing, on a control server, information on profiles of said multiple operators including current operator location and operator home location;

receiving, as input to the control server, information on the transports from users planning the transports, including for each transport:
the origin, and
the destination;

determining, using the control server, from the information on the transports, which of the transports are compatible having routes which can be overlapped;

determining, using the control server, switch-points for the compatible transports at which operators are to change based on the profiles of the operators and the information on each transport, wherein selected ones of the operators are assigned to the transports;

and dispatching to the assigned operators using the control server an itinerary including an outbound trip and return trip for each assigned operator comprising for each of the outbound and return trips: the respective one of the vehicles to be operated, departure information therefor, and arrival information therefor, such that each assigned operator returns to the operator home location.

In some instances, one of the operators may be a control system of the vehicle which is configured to autonomously operate the vehicle without input from a human operator.

According to a further aspect of the invention there is provided a system and method for assigning vehicles to available operators who are located at a current or a predicted future location of a respective one of the vehicles. The system is able to automatically determine the geographical points where a vehicle switches operators based on factors including maximum operating time permitted by legal regulations, such that an operator that can no longer continue to drive the truck as the regulation driving time has been met, and as such the system is able to assign a new operator so that the vehicle substantially remains in transit towards its destination without having to sit or rest idle for a unduly prolonged time due to the lack of a suitably available operator to operate the vehicle.

At the switch-points an initial one of the assigned operators which has delivered the vehicle to the switch-point vacates said vehicle so that the next operator continues the trip taking the vehicle from said switch-point to the next stop or waypoint of the trip of the vehicle.

Typically, each transport involves the same vehicle carrying/towing the same load from the origin of the trip to the destination, and is owned by the user planning the transport.

Preferably, the method includes collecting, from a plurality of sensors on each vehicle, information about a status of the operator, a status of the vehicle and the trip it is on, so as to determine how the operator and vehicle can be involved in the transport being arranged.

Preferably, the step of collecting information from the plurality of sensors is performed in real-time such that the switch-points can be determined in real-time.

Preferably, the information which is collected from the plurality of sensors is stored so that previously collected information is utilizable to determine the switch-points.

That is, switch-points can be determined using both historical data and real-time data.

In one arrangement, there is disposed in each vehicle an intermediary electronic communications device which receives the information from the sensors and transmits the information to the control server.

In one arrangement, the intermediary electronic communications device is configured to control data collection via the sensors.

Preferably, the data transmitted from the intermediary electronic communications device to the control server includes raw data and synthesized data.

Synthesized data includes raw data which has been processed to some extent. In some instances, such processing allows for the originating raw data to be interpretable within the context in which it was collected, which is more readily understood by the intermediary electronic communications device communicated with the sensors obtaining the raw data as compared to the control server, such that when the control server receives the data it can readily utilize or apply the data.

Typically, the information sent to the assigned operators from the control server is performed over a wireless communication network to a portable electronic device which can communicate over the network.

Preferably, the method includes a step of collecting information from real-time data feeds. For example, these include traffic, weather, and fuel prices.

Preferably, the itineraries are sent to portable electronic devices over the wireless communication network.

That is, the portable electronic devices do not have fixed geographical location.

Typically, the portable electronic devices are configured to receive notifications about changes or modifications to the itineraries.

Preferably, the portable electronic devices are configured for communication with the control server.

Preferably, the profiles of the multiple operators additionally include:
a prescribed number of hours of operating a vehicle within a predetermined time period;
a prescribed distance of travel from the operator home location;
operator history; and
qualifications for loads which can be transported.

Preferably, a time of operating the vehicle is monitored by a sensor transmitting data to the control server so that the respective switch-point can be determined to enable the respective operator to operate vehicles for no longer than the prescribed number of hours of the operator's profile.

Preferably, a distance of travel of the vehicle is monitored by a sensor transmitting data to the control server so that the respective switch-point can be determined to enable the respective operator to operate vehicles for no further than the prescribed distance of travel of the operator's profile.

Preferably, the input from the user additionally includes:
prescribed operator profile;
priority of transport; and
information on loads which are to be transported.

Preferably, after operators are changed at the respective switch-point the vehicle returns to motion on its trip towards the destination so as to minimize time during which the vehicle is idle during the trip.

Thus is provided a system from which, for example, trucking companies could benefit to plan out fast ways of getting their truck from a respective origin to a respective destination by being able assign specific available drivers that can share the responsibility of getting the truck to its destination, which is different from a conventional approach where one specific driver is responsible for the entire trip. This may allow trucking companies to overcome constraints on efficiency of the industry, such as regulations on drivers which limit their daily driving hours.

### BRIEF DESCRIPTION OF THE DRAWINGS

The invention will now be described in conjunction with the accompanying drawings in which:

FIG. 1 is a schematic illustration of an embodiment of system implementing a method for arranging transport according to the present invention, in which there is shown a pair of transports achieved by assignment of multiple operators;

FIG. 2 is a schematic illustration of the embodiment of FIG. 1 showing interaction between system users and a database stored on a control server of the system;

FIG. 3 is a schematic illustration of the embodiment of FIG. 1 showing specific components of the system enabling same to arrange the transport(s);

FIG. 4 is a schematic illustration of communications within the embodiment of FIG. 1; and

FIG. 5 is a flow diagram of the method performed by the embodiment of FIG. 1.

In the drawings like characters of reference indicate corresponding parts in the different figures.

### DETAILED DESCRIPTION

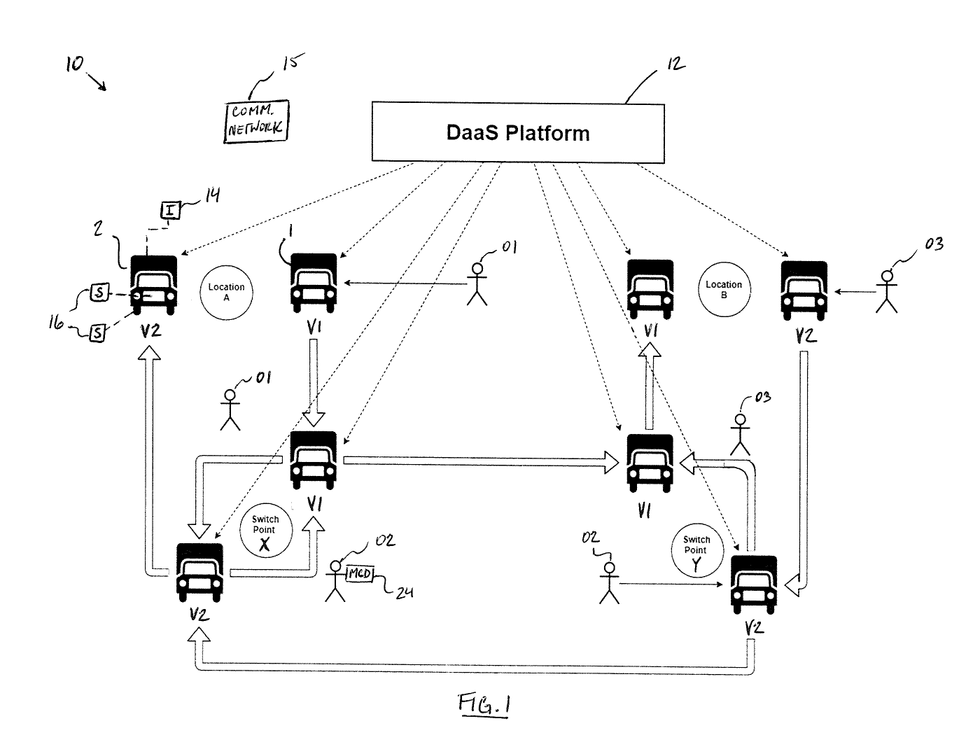

There is illustrated in the figures a system 10 for arranging a transport, typically of goods, via a vehicle 1, 2 such as a semi-tractor with an attached trailer from an origin location to a destination location using multiple human operators such as those indicated at O1 through O3 in FIG. 1, which may alternatively be referred to as drivers since the example used herein is that of land transportation. That is, each of the multiple operators O1-O3 operates the vehicle 1 for a portion of a trip between the origin and destination locations for the transport, that is a route taken between the starting and end locations for the transport. As such, in the system described herein, the same vehicle 1, 2 makes the entire trip from the origin to the destination of the transport, but it is operated by multiple different individuals O1-O3 who do not travel with the transport for the entirety of the trip. That is, each operator travels only a portion of the overall distance of the trip from one point along a trip route to another point at which the current operator physically removes himself from the vehicle and a different operator takes over control and operation of the vehicle for a further portion of the trip. Typically, any one operator assigned to a transport travelling from origin to destination does not travel another portion of the trip.

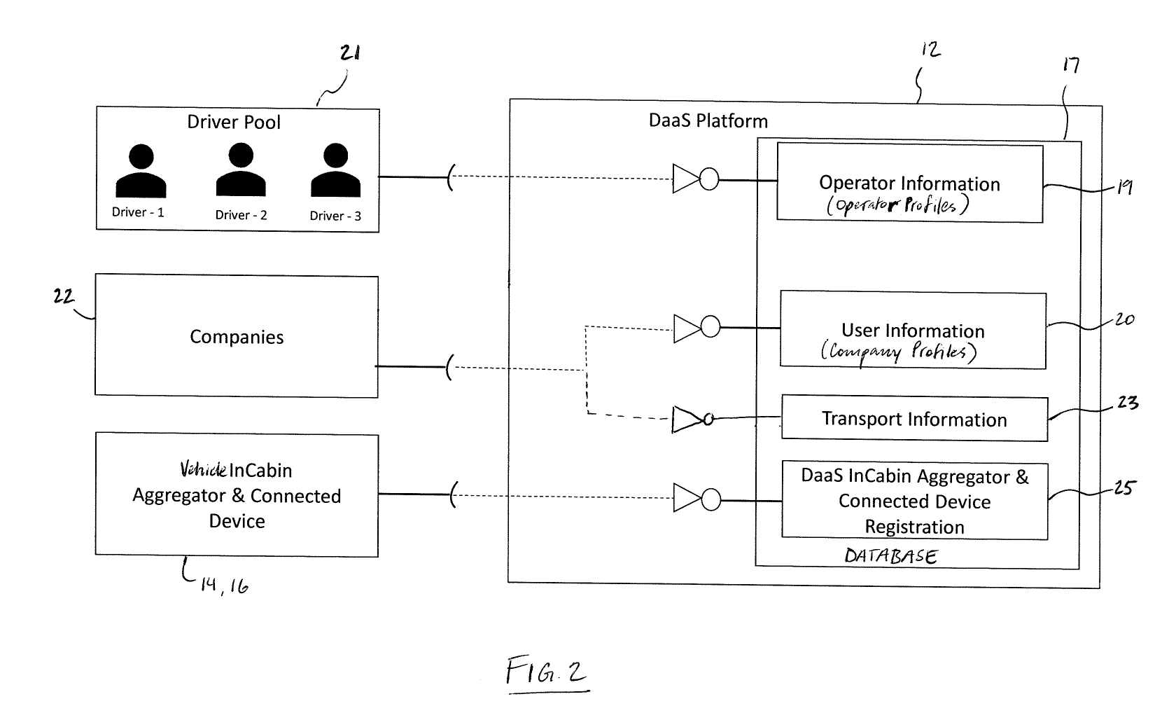

A transport arranged or managed in the forgoing manner utilizes a computerized system 10 with a number of interacting components which are illustrated in more detail in FIGS. 2-4. To make such transports even more efficient, the system 10 is able to handle a plurality of transports which are to be arranged via a plurality of different vehicles such as those indicated 1 and 2 in FIG. 1, each travelling from a different origin to a different destination, where at least some of the operators assigned to one transport are reused for another transport such that the operator is enabled to travel back towards, and preferably return to, their departure location which is typically a home location.

FIG. 1 illustrates an example of two transports arranged by the system 10, in which vehicle 1 forming a first transport departs from starting location A on a trip to end location B. Conversely, vehicle 2 forming a second transport departs from starting location B on a trip to end location A. In this example, the system assigns three operators O1 through O3 to take each of the first and second transports along their full trip. Operator O1's home location is location A, operator O2's home location is switch-point Y, and operator O3's home location is location B.

Still referring to FIG. 1, in the case of vehicle 2, operator O3 operates the vehicle 2 for a first portion or leg of its respective trip from starting location B to a first switch-point Y, at which operator O3 changes with operator O2, who is located at switch-point Y, so that operator O2 operates the vehicle 2 for a second portion or leg of its respective trip from switch-point Y to switch-point X. In the meantime, operator O1 is operating vehicle 1 to take it along a first portion of its respective trip from starting location A to switch-point X. When both vehicles 1 and 2 have arrived at switch-point X, with respect to vehicle 2 operator O2 changes with operator O1 so that the latter operates vehicle 2 for the third and, in this example, final leg of its trip from switch-point Y to end location A. Furthermore, with respect to vehicle 1 located at switch-point X, operator O1 changes with operator O2 so that the latter operates vehicle 1 for a second portion of its trip from switch-point X to switch-point Y. At switch-point Y, operator O2 changes with operator O3, who is located thereat after vacating vehicle 2 subsequent to completion of the first leg of vehicle 2's trip and who operates vehicle 1 for the third and final leg of its trip from switch-point Y to end location B. In this manner, each of vehicles 1 and 2 has completed its full trip, each having been operated by more than one operator and during each leg by a different operator, and each operator has returned to his/her respective home location.

The system 10, which is configured to arrange the transports as described by the forgoing example, comprises:

1) a central control server 12, which may be referred to herein and in the accompanying figures as “DaaS Platform” for convenient reference;

2) an intermediary portable electronic communications device 14, which is configured for wireless communication with the control server 12 over a wireless communication network 15 (shown schematically) and which may be referred to herein and in the accompanying figures as “Daas InCabin Aggregator” for convenient reference; and

3) a plurality of sensors 16 configured for wireless communication with the intermediary device 14 and the control server 12, which may be referred to herein and in the accompanying figures as “Daas Connected Devices” for convenient reference.

The central control server 12 serves as the main “brain” of the system 10 and performs the bulk of the processing of the system 10 in order to arrange the transports as described above. Referring to FIG. 2, the control server 12 maintains a database 17 of information including operator profiles 19 and profiles of companies 20 who are commissioning the transports and own the vehicles such as those indicated 1 and 2 which are used for the transports. This information is used in the processing of the system 10 to assign or select operators, like those indicated O1 through O3, for each transport and to determine transports which can have overlapping routes so that each assigned operator can return via a different transport to his/her initial departure location.

Each operator who wishes to offer his/her services in operating a transport vehicle for the purposes of the system 10, such as O1-O3, registers with the system and creates a profile 19 by inputting information such as:

a) operator preferences including:
a prescribed number of hours of operating a vehicle within a predetermined time period;
a prescribed distance of travel from the operator home location;
schedule or availability of the operator;
operator home location;
a particular route with which the operator is familiar;
a particular type of goods for transport that the operator is familiar with; and
desired (financial) compensation;

b) operator eligibility including qualifications for loads which can be transported, such as in the form of official certifications issued by designated authorities which can be for example with respect to handling of dangerous goods or livestock, and details of visa;

c) operator history, for example duration of work experience, collision or accident history, and background check; and

d) operator contact information such as phone number, e-mail address, and mailing address.

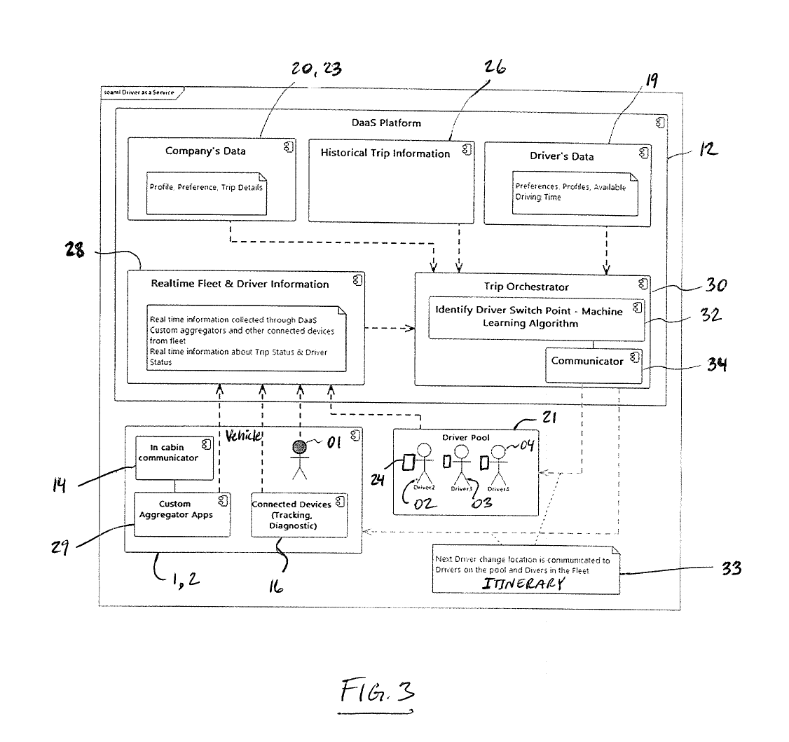

This information is input to the control server 12 through for example an application program interface (API). Operators O1-O3 collectively form a pool 21 of potential operators registered with the system 10 that can be subsequently selected when arranging a transport. Thus, the pool 21 of registered operators includes at least operators O1-O3 but may include others, for example operator O4 who is shown in FIG. 3.

Still referring to FIG. 2, each company 22 wishing to participate and thus contract operators O1-O3 to their transports using the system 10 registers therewith and creates a profile 20 by inputting information similar to that above for each operator, and thus generally including:

a) company preferences;

b) company eligibility;

c) company history, including satisfaction reviews; and

d) company contact information.

Companies 22, or in other words users looking to exploit the functionality of system 10, input their information to the control server 12 via an application program interface. Typically these companies 22 have fleets of vehicles and thus the respective vehicle

The forgoing information, that is the information on the operators like O1 through O3 and the companies 22, is stored in the database 17 on the control server 12 for subsequent access and retrieval when processing the transports to find compatible transports, as will be elaborated shortly, and to assign operators from the registered pool 21.

The control server 12 is also configured to receive as input, through an application program interface (API) or portal, information on the transports 23, from the users, that is the companies 22, who are planning the transports. This registration information 23 for the respective transport which is to be subsequently arranged by the system 10 includes:

i) origin;

ii) destination;

iii) waypoints;

iv) the vehicle assigned for the transport;

v) consignment information, i.e., information on goods which are to be transported, for example dangerous goods, livestock, food;

vi) proposed departure date and time from the origin of the transport and arrival date and time at the destination;

vii) importance classifier, for example indicating a priority of the transport, so as to provide flexibility when assigning routes and operators to the transport; and

viii) prescribed operator profile, which is checked against the profiles 19 input by the registered operators 21 for a best match, for example a company may request an operator to have a prescribed duration of experience, a prescribed safety record, and a particular certification.

Thus, once the transport information 23 is input by the respective user 21 and received by the control server 12, the control server 12 determines switch-points for the respective transport, at which operators are to change. The switch-points such as those indicated X and Y in FIG. 1 are determined based on the profiles 19 of the registered operators from the pool 21 and the information on the registered transport(s) 23, and in this step of determining switch-points, selected ones of the operators such as O1-O3 in FIG. 1 are assigned to the respective transport. Typically, at this stage, current operator location as determined by a GPS locator, for example of a mobile communication device 24 carried by the respective operator such as a smart phone, is also used to determine those operators which are to be assigned to the respective transport.

It will be appreciated that the system 10 described herein may be used to assign to a single transport selected ones of the registered operators such as O1-O3 in FIG. 1, which are best suited for executing the transport within the parameters thereof as identified by the planning user/company 22. However, a more practical scenario is one in which a plurality of transports have been registered at 23, and to maximize efficiency, the control server 12 determines from the information on the registered transports 23 which ones are compatible. Compatibility is based on, for example, the possibility of arranging the transport to have routes which can be overlapped, whether there is a prescribed route that is already provided by the company 22 arranging for the transport or whether there is some flexibility in this, and overlapping dates and times between which the transports are to take place. While a trip for a transport has pre-specified starting and end locations, as designed by the planning user 22, a route is not set and is to be determined by the control server 12 at the time of calculating the switch-points that will define the route of the trip. Overlappable routes are those which can be planned to have common waypoints. As such, in determining the switch-points as described previously, the control server 12 determines the switch-points for the compatible transports so as to be considering only a limited number of transports and not all that are registered in the system at 23.

As more clearly shown in FIG. 1, each vehicle which can be used for a transport, for example that indicated at 1 or 2, has installed in it one of the intermediary electronic communications devices 14, and a set of the sensors 16 which are monitoring a status of the operator O1-O3 currently operating the vehicle 1, 2; a status of the vehicle 1, 2 including fuel level, engine diagnostic information such as engine temperature, and tire pressure in the case of a semi-tractor (all of which can be referred to as vehicle diagnostic information); and a status of the trip the vehicle is on as part of its transport. These devices 14, 16 are registered in the database 17 by inputting information 25 to the control server 12 so as to specify which devices belong to and therefore identify a particular vehicle 1, 2 and a particular user 22.

The status information is collected from the sensors 16 mounted to the vehicle 1, 2 and transmitted to the control server 12, whether transmitted from the sensors 16 directly to the control server 12 or transmitted to the intermediary communications device 14 which subsequently transmits the data to the server 12 after processing some of the collected data so as to present synthesized data to the control server. That is, the intermediary device 14 is configured to forward to the control server 12 both raw data and synthesized data. Synthesized data comprises raw data which has been processed to some extent. In some instances, such processing allows for the originating raw data to be interpretable within the context in which it was collected, which is more readily understood by the intermediary electronic communications device 14 communicated with the sensors 16 obtaining the raw data as compared to the control server 12 which is located remote to the sensors 16 (and, generally speaking, the vehicle 1 or 2), such that when the control server 12 receives the data it can readily utilize or apply that data. When a channel for transmitting vehicle-specific data is defined by the intermediary communications device 14, this device is typically configured to control data collection via the sensors 16. In a further alternative, the sensors 16 can communicate with the control server 12 via a channel comprising a user's private server (not shown), which is then communicated with the control server 12 of the system 10.

Data collection from the sensors 16 is performed in real time. Referring to FIG. 3, this data is also stored on the control server 12 at 26 for subsequent retrieval such that previously collected sensor information 26 is utilizable to determine switch-points. As such, switch-points can be determined using both historical data 26 and real-time data indicated at 28.

Additionally, the server 12 collects at 28 information from real-time data feeds, such as traffic, weather, and fuel prices, with which it is connected over a data communications network (whether mobile data, Internet).

A time of operating the vehicle 1, 2 is monitored by a respective one of the sensors 16 mounted to the vehicle so as to be operatively coupled thereto, which is transmitting data to the control server 12 so that the respective switch-point can be determined to enable the respective assigned operator O1-O3 to operate vehicles for no longer than the prescribed number of hours of the operator's profile stored at 19.

Additionally, a distance of travel of the vehicle is monitored by a respective one of the sensors 16 mounted to the vehicle so as to be operatively coupled thereto, which is transmitting data to the control server 12 so that the respective switch-point can be determined to enable the respective assigned operator O1-O3 to operate vehicles for no further than the prescribed distance of travel of that operator's profile stored at 19.

The intermediary communications device 14 has stored on its memory at least one program or application 29 with instructions to be executed on the processor of the device 14 allowing it to communicate with the sensors 16 in a manner to collect and process the appropriate data which can subsequently be used in planning transports. This one or more application/program 29 may be referred to herein and in the accompanying figures as “Custom Aggregator Apps” for convenient reference.

As such, as illustrated in FIG. 3, in determining the switch-points, further to having already determined which transports can have compatible routes, the control server 12 searches amongst the pool 21 of the registered operators by taking into account:

already stored operator profiles 19,

the current operator location which is determined by a GPS locator on a portable device on the operator's person 24, or a GPS locator in the form of a respective one of the sensors 16 tracking location of the vehicle 1, 2 being operated by the respective operator—this forms one portion of the real-time data 28,

and taking into account real-time data including the status of the vehicles, traffic, and other conditions which can indirectly affect the trip of the transport, for example adverse weather conditions which may delay arrival at a particular location—forming the other portion of the real-time data considered by the control server 12 at 28.

Thus, in the illustrated arrangement discussed in detail here, the determination of switch-points when arranging the transport(s) includes a vast variety of data types which are collected by the server 12 in real-time and processed on the server 12 by a trip orchestrating module 30 running an algorithm 32 which optimally meets the conditions of each registered transport. The information considered by the trip orchestrating module 30 includes, for example:

real-time information collected at 28 including:
real-time navigation information from the vehicles 1,2, which is received from the sensor(s) 16 mounted in the respective vehicle;
diagnostics information from the vehicles 1,2 received from the sensors 16 monitoring same;
operators' current operating times, which for an active operator controlling a vehicle 1, 2, like O1 as shown in FIG. 3, is received from the sensor 16 mounted in the respective vehicle monitoring same and which for standby and thus inactive operators of the available pool 21, like O2-O4 of FIG. 3, can be tracked by applications stored in memory on the mobile communication device 24 carried by the respective operator O2-O4 on their person;
real-time traffic information and fuel prices;

operators' preferences as described in their profiles 19 retrieved from database 17;

planning company's 22 preferences stored at 20 in the database 17 and registered trip information stored at 23;

whether a transport meets border crossing rules retrieved from 23;

historical information about efficiency of previous transports which have taken the same or similar routes retrieved from 26.

To process all of this information, the algorithm 32 of the illustrated arrangement is a machine learning algorithm, such as a neural network, which seeks to learn from previously collected data and previously arranged transports stored at 26 so as to better optimize future transports to be arranged.

As part of determining the switch-points, selected ones of the registered available operators like O1-O3 as shown in FIG. 1 are assigned to a particular one of the transports, and thus the control server 12 dispatches an itinerary 33 to each operator. The itinerary 33 includes, at least, the vehicle to be operated, departure information for the transport such as departure location and time, and arrival information for the transport including arrival location and time. As discussed previously, several transports are coordinated to maximize efficiency, and in such instances the itinerary for the respective assigned operator O1-O3 includes a first trip leg and a second trip leg, and for each of these: the respective one of the vehicles to be operated, departure information therefor, and arrival information therefor. Typically, it is desired that by the second trip leg the assigned operator has returned to his/her home location. The first and second trip legs may alternatively be termed outbound and return trips, respectively, particularly when at the end of the return trip the operator is located at a closer distance to his/her home location in comparison to a distance between operator home location and the operator location at the end of the outbound trip. The system can arrange to locate an operator at the end of the second trip leg at a location other than the operator home location depending on factors including the operator preferences in the assigned operator's profile, such as duration away from home location, and a remaining amount of operating time as tracked by the sensors, which is the different between the operator's current total operating time in a prescribed period of time and the maximum operating time for which the operator is eligible to operate any transport vehicle in that prescribed period of time based on legal regulations, which can be a period of 24 hours or a single calendar day.

The itineraries are dispatched by the control server's communicator module 34 to the assigned operator O1-O3 over the wireless communication network 15 to a portable electronic device, which in the illustrated arrangement is the respective intermediary electronic communications device 14 installed in the respective vehicle. This device displays the itinerary 33 to the operator. Further, the portable electronic device 14, which is portable in the sense that it does not have a fixed geographical location (but may be fixed in location to a specific vehicle), is configured to receive notifications about changes or modifications to the itineraries 33. Such changes or modifications may come about due to information obtained from a real-time traffic data feed from 28 indicating that there is a road closure or impasse which will delay the trip, or where one of the previously assigned operators is no longer available then the trip, whether the route of the trip or the switch-point, may be different to accommodate the newly assigned operator with whom the vehicle will be swapped.

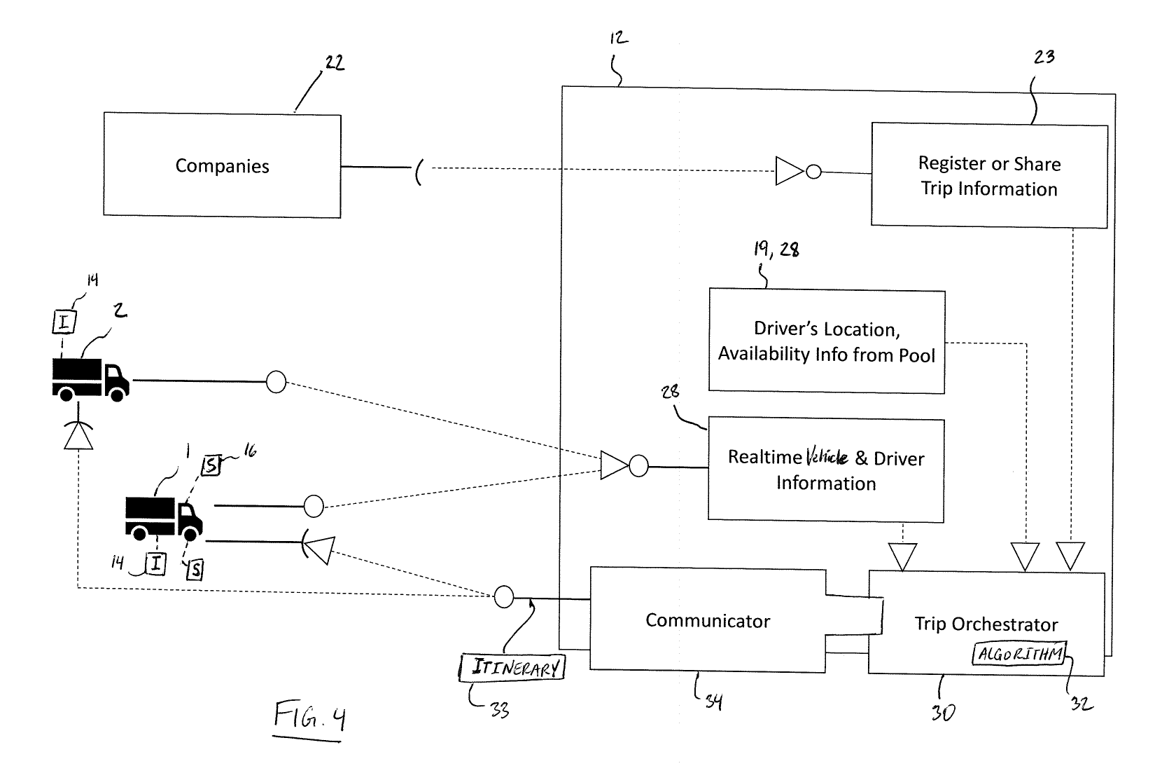

FIG. 4 illustrates how information is communicated within the system 10 in order to arrange the transports. Companies 22 input information 23 to the control server 12 regarding the transports 23 that they want to have arranged. This information 23 is retrieved by the trip orchestrator 30 in order to perform the task of arranging the transports stored at 23, during which the trip orchestrator 30 also retrieves (i) data from the registered operator profiles 19 including availability of all registered operators of the pool 21, (ii) current operator locations obtained at 28 from standby operators via their mobile communication devices 24, (iii) current locations of active operators obtained at 28 via the vehicle-mounted sensors 16, and (iv) other information about the vehicles 1, 2 currently in use, i.e. active transport, retrieved via the sensors 16 mounted in same. Once the trip orchestrator 30 has applied the processing algorithm 32 to all the forgoing information, the communicator module 34 transmits the itinerary 33 for the respective transport to the vehicles 1, 2 designated as being involved in same, and the assigned operators.

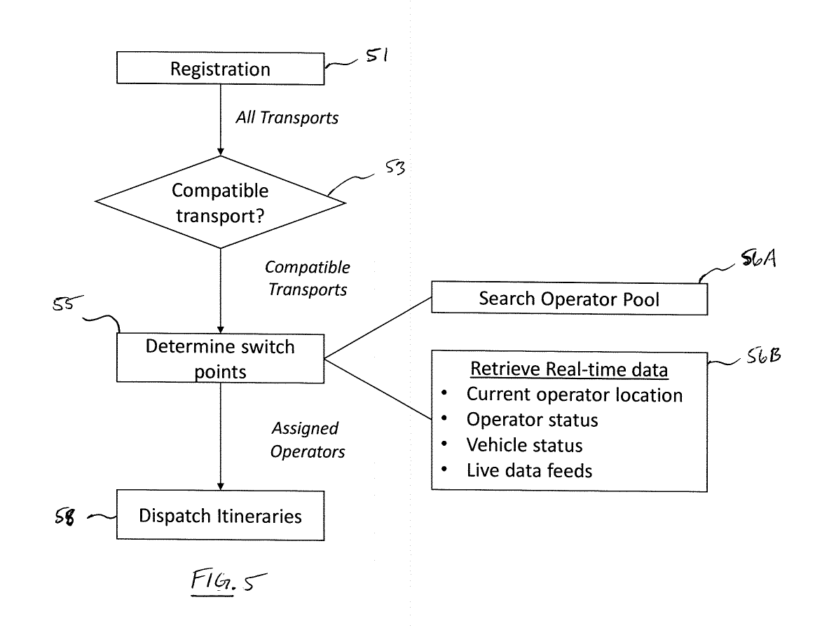

Thus, a method by which the system 10 of the illustrated arrangement operates comprises the following steps as illustrated in FIG. 5:

1) Receiving registration information, as indicated at step 51, regarding operators who wish to offer their services thereby forming the pool 21, users 22 wishing to contract operators using the system 10 who provide their own profiles 20 as well as information on the transports 23 which they are looking to have executed. All this information is input by individuals who are remote to the control server 12;

2) Based on the information on the transports 23 when more than one transport is registered, determining, using the control server 12, which of these transports can have routes which can be reasonably overlapped so as to be deemed compatible, as indicated at step 53. This may involve processing a plurality of possible routes for each transport, for example fastest routes, and seeing which pass or can pass through common waypoints;

3) For those transports which are compatible, determining switch-points therefor by calculating an optimal combination of available registered operators from the pool 21 and optimal locations where any pair of operators can change, as indicated at step 55. This involves at 56A searching the pool 21 of registered and available operators by retrieving operator profiles, and retrieving real-time data at 56B including determining current operator location, determining real-time statuses of registered vehicles 1, 2 and registered operators, and collecting information from real-time data feeds such as live traffic feeds. For example, vehicle status information may be utilized to determine a suitable switch-point by considering the fuel level of the vehicle, such that a gas station is designated as a switch-point where the vehicle can refuel to optimize time and efficiency of the trip. In another example, an up-to-date electronically accessible directory of “points of interest” such as designated truck stops, gas stations, and rest areas may be searched so as to select a safe switch-point, for example based on the operator profile. Additionally, live traffic data can be accessed by the control server 12 so as to predict an arrival time for a vehicle 1, 2 at a switch-point, and to recalculate a switch-point if necessary. Therefore, in this step of determining switch-points 55, selected ones of the available registered operators are assigned to each transport which is supposed to arrive at the switch-point location;

4) Once the switch-points are calculated, dispatching in real-time an itinerary 33 to the assigned operators. as indicated at step 58, who may be actively operating one of the vehicles or who may waiting as they are not currently working, so that they possess the information to be able to arrive at the designated switch-point and continue the trip of whichever vehicle they are to operate. The communicator 34 of the control server dispatches the itineraries 33 over the wireless communications network 15 to the portable electronic devices 14 viewable by the operators. The portable device may be connected directly to the wireless communications network, as for example a cellular network, or may be connected indirectly thereto over Wi-Fi.

It will be appreciated that in some instances, at least one of the assigned operators may be a control system of the vehicle being used for the transport, which is configured to operate the vehicle autonomously without any input from a human operator. Thus, for example, in a journey from origin A to destination B, a truck can be driven autonomously by the vehicle control system from the origin to point X (where X is a stop outside city limits) at which a human operator assumes control from the control system and operates the truck from point X to destination B.

The scope of the claims shall not be limited by the preferred embodiments set forth in the examples, but shall be given the broadest interpretation consistent with the description as a whole.

1. A method for arranging a transport via a vehicle travelling from an origin to a destination using multiple operators each operating the vehicle for a portion of a trip between the origin and destination, the method comprising the steps of:
storing, on a control server, information on profiles of said multiple operators including operator location;
receiving, as input to the control server, information on the transport from a user planning the transport, including:
the origin, and
the destination;
determining, using the control server, switch-points for the transport at which operators are to change based on the profiles of the operators and the information on the transport, wherein selected ones of the operators are assigned to the transport;
and dispatching to the assigned operators using the control server an itinerary comprising the vehicle to be operated, departure information therefor, and arrival information therefor.

2. The method according to claim 1 wherein there are a plurality of transports to be arranged via a plurality of vehicles, and the method further comprises a step of determining, using the control server, from the information on the transports, which of the transports are compatible having routes which can be overlapped, and the itinerary for each assigned operator includes a first trip leg and a second trip leg at the end of which said assigned operator is arranged at a next operator location which is dependent upon a respective one of the profiles of said assigned operator.

3. The method according to claim 1 comprising collecting, from a plurality of sensors on each vehicle, information including a status of the operator, a status of the vehicle and the trip it is on, so as to determine how the operator and vehicle can be involved in the transport to be arranged.

4. The method according to claim 3 wherein the step of collecting information from the plurality of sensors is performed in real-time such that the switch-points can be determined in real-time.

5. The method according to claim 3 wherein the information which is collected from the plurality of sensors is stored so that previously collected information is utilizable to determine the switch-points.

6. The method according to claim 3 wherein there is disposed in each vehicle an intermediary electronic communications device which receives the information from the sensors and transmits the information to the control server.

7. The method according to claim 6 wherein the intermediary electronic communications device is configured to control data collection via the sensors.

8. The method according to claim 6 wherein the data transmitted from the intermediary electronic communications device to the control server includes raw data and synthesized data.

9. The method according to claim 1 further comprising a step of collecting information from real-time data feeds.

10. The method according to claim 1 wherein the itineraries are sent to portable electronic devices over a wireless communications network.

11. The method according to claim 1 wherein the portable electronic devices are configured to display notifications about changes to the itineraries.

12. The method according to claim 1 wherein the profiles of the multiple operators also include:
a prescribed number of hours of operating a vehicle within a predetermined time period;
a prescribed distance of travel from the operator home location;
operator history; and
qualifications for loads which can be transported.

13. The method according to claim 12 wherein a time of operating the vehicle is monitored by a sensor transmitting data to the control server so that the respective switch-point can be determined to enable the respective operator to operate vehicles for no longer than the prescribed number of hours of the operator's profile.

14. The method according to claim 12 wherein a distance of travel of the vehicle is monitored by a sensor transmitting data to the control server so that the respective switch-point can be determined to enable the respective operator to operate vehicles for no further than the prescribed distance of travel of the operator's profile.

15. The method according to claim 1 wherein the input from the user also includes:
prescribed operator profile;
priority of transport; and
information on loads which are to be transported.

16. The method according to claim 1 wherein after operators are changed at the respective switch-point the vehicle returns to motion on its trip towards the destination so as to minimize time during which the vehicle is idle during the trip.
